(19) United States
(12) Patent Application Publication
(10) Pub. No.: US 2007/0042316 A1
(43) Pub. Date: Feb. 22, 2007

(54) Nozzle piece for a dental powder jet apparatus

(76) Inventors: Patrick Pichat, Annemasse (FR); Nicole Henry, Gland (CH); Rolf Meissner, Gilly (CH); Andreas Menne, Signy (CH)

Correspondence Address: OSTROLENK FABER GERB & SOFFEN, 1180 AVENUE OF THE AMERICAS, NEW YORK, NY, 100368403, US

(21) Appl. No.: 10/564,043

(22) PCT Filed: May 25, 2004
(86) PCT No.: PCT/EP04/05610

§ 371 Date: Jun. 30, 2006

(30) Foreign Application Priority Data
Jul. 11, 2003 (DE) 103315837

(51) Int. Cl. A61C 17/02

(52) U.S. Cl. 433/80; 433/88

(57) ABSTRACT

A nozzle piece for a dental powder jet apparatus is provided with a discharge nozzle, the outlet cross section of which is formed by few nozzle openings in the lateral area of the front end of a tube-shaped partial length of the nozzle piece, for a primarily sub-gingival cleaning of the tooth radix surfaces with particularly fine-grained dental powders.

The invention relates to a nozzle piece for a dental powder jet apparatus provided for an exchangeable assembly on a hand piece, having a discharge nozzle for discharging a mixture of air and a dental powder adapted for cleaning teeth, of the type defined in the pre-characterizing portion of claim 1.

In the nozzle piece of this type known from U.S. Pat. No. 5,765,759, the outlet cross section of the discharge nozzle is composed of the open end of a relatively short tube attached to the nozzle piece by means of a screw piece. An open inlet end of the tube is connected to a mixing chamber formed within the nozzle piece. Two communication passages formed within the nozzle piece are connected to the mixing chamber for separately supplying air and an air-powder-mixture. The nozzle piece is rotatably disposed on the head portion of a hand piece, the head portion forming an integrated grip, whereby the tube forms an obtuse angle with the rotational axis of the nozzle piece and may be adjusted to different angular alignments of its outlet cross section relative to the hand piece. The known nozzle piece thereby allows for a supra-gingival powder jet cleaning of tooth surfaces having regard to individual requirements of the patient.

DE 101 14 324 A1 discloses a nozzle piece in which a discharge nozzle for an air-powder-mixture is surrounded by a concentrically arranged outer discharge nozzle for discharging a fluid. The two discharge nozzles are connected via connection passages with two separate connecting lines within a separate grip, which is attached to the head of a hand piece. By means of a nozzle piece of this type, all kinds of supra-gingival powder jet cleaning functions with simultaneous fluid spraying of the treated teeth surfaces may be carried out, in order to vary the treatment of the tooth surfaces during a tooth cleaning session.

Conventionally, sodium bicarbonate powders of different grain sizes or powder mixtures containing sodium bicarbonate powder as main component have been used for tooth cleaning carried out by means of a powder jet apparatus using the above-described nozzle pieces. These powders have an abrasive effect and thus also lead to a roughening of the treated supra-gingival tooth surfaces. In addition, there is a risk of injuring the supra-gingival tooth surfaces, in particular in the neck area of the teeth. Therefore, at has lately been attempted to use rather very fine-grained dental powders of lower densities than those of the abrasive powders used for powder jet cleaning of supra-gingival surfaces until now.

Such rather fine-grained powders and/or powder mixtures for use in supra-gingival tooth cleaning are described for example in DE 114 416 A1. In this document, a powder density of no more than 2,0 g/cm³ is indicated with the additional specification that an abrasion of the tooth surface of no more than 0.10 mm³, caused by a powder jet with a conventional nozzle piece, should be achieved, based on a tooth surface of 9.6 mm², a jet duration of 2 minutes with a jet pressure of 4 bar and a distance between the tooth surface and the mouth of the discharge nozzle for the air-powder-mixture of not more than 2.5 mm. Using such powders, a substantial loss of not regenerating dental hard tissue can apparently not be avoided, also during several repetitions of the jet treatment. In addition, not only common impurities and colorations of the visible dental hard tissue may be removed, but also invisible or barely visible plaque residues, in particular accretions originating from micro organisms. The same powder is also proposed in DE 199 10 559 A1 for use in a sub-gingival powder jet cleaning process, wherein no substantial differentiation was made with respect to supra-gingival powder jet cleaning.

When testing these rather fine-grained dental powders using the nozzle pieces conventionally used during a powder jet cleaning, it has been found that largely atraumatic tooth treatments appear hardly possible. A special criterion which emerged in these tests was the (absent) possibility to reach the radix surfaces when working within the gum pockets. The nozzle pieces conceived so far have proven to be unsuitable or hardly suitable for such application.

It is an object of the invention to provide a novel nozzle piece of the type described above, which is suitable for use with especially finally grained dental powders and/or powder mixtures with lower densities than the abrasive powders used until now, and which should allow a sub-gingival, largely atraumatic powder jet cleaning of tooth radix surfaces.

In a nozzle piece of the type specified above, in which a front partial length at the outlet cross section of the discharge nozzle extends over a grip of the nozzle piece to the outside, the grip being attached to a hand piece, wherein the front partial length has the shape of tube, the object of the invention is solved by forming the outlet cross section of the discharge nozzle with a few nozzle openings in the lateral area of the front end of the tube-shaped partial length of the nozzle piece.

In the nozzle piece according to the invention, a largely atraumatic insertion of the discharge nozzle into the gum pockets is primarily achieved by a tube-shaped arrangement of the partial length of the nozzle piece extending to the outlet cross section of the discharge nozzle. The length of the tube may be about 15 mm, in order to allow a simple insertion of the front end of the tube up to a depth of about 5 mm, also in the back gum pockets. The nozzle openings formed in the lateral area of this front end of the tube result in a powder jet divided into multiple jets, which may reach the surface of the tooth radixes without problem even when fine-grained powders and/or powder mixtures of a relatively low density as described above are used. The nozzle piece according to the invention is therefore expected to result in an optimal sub-gingival powder jet cleaning with such fine-grained dental powders.

For sub-gingival powder jet cleaning, several geometries of the discharge nozzle and designs and arrangements of the nozzle openings in the lateral area of the front end of the tube-shaped partial length of the nozzle piece may be considered in order to optimize the sub-gingival powder jet cleaning according to individual requirements within the scope of an experimental testing. For this optimization, the front axial end of the tube may be closed, wherein the closed end may alternatively be provided with an additional axial nozzle opening in accordance with a further embodiment of the nozzle piece according to the invention. Also, a second discharge nozzle for the supply of fluid may be provided in order to generate a spray cloud with such fine grained dental powders and/or powder mixtures of relatively low density during the sub-gingival tooth treatment, the cloud reducing a possible exposure to dust during the treatment.

Several embodiments of the nozzle piece according to the invention, which may be particularly advantageous and which are also defined in the patent claims, are schematically shown in the drawing and shall be described in the following in detail. In the drawings:

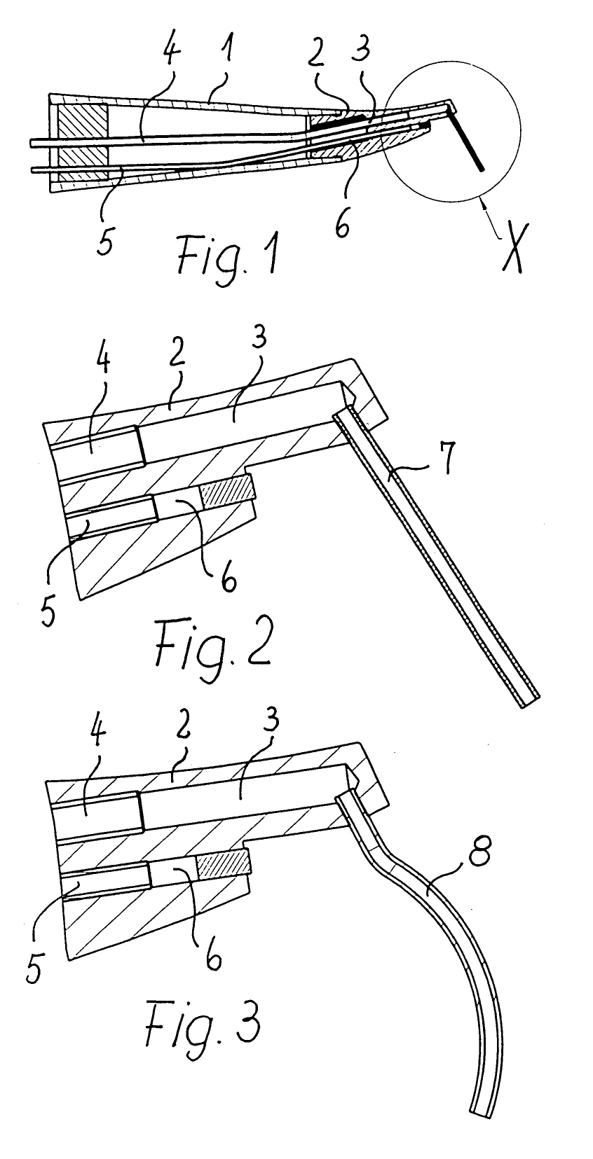

FIG. 1 shows a strongly schematic representation of the head of a known hand piece of a powder jet apparatus, for which the nozzle piece indicated at detail X may be designed according to the invention,

FIG. 2 shows an enlarged cross sectional view of the nozzle piece indicated at detail X in FIG. 1 according to a preferred embodiment of the invention,

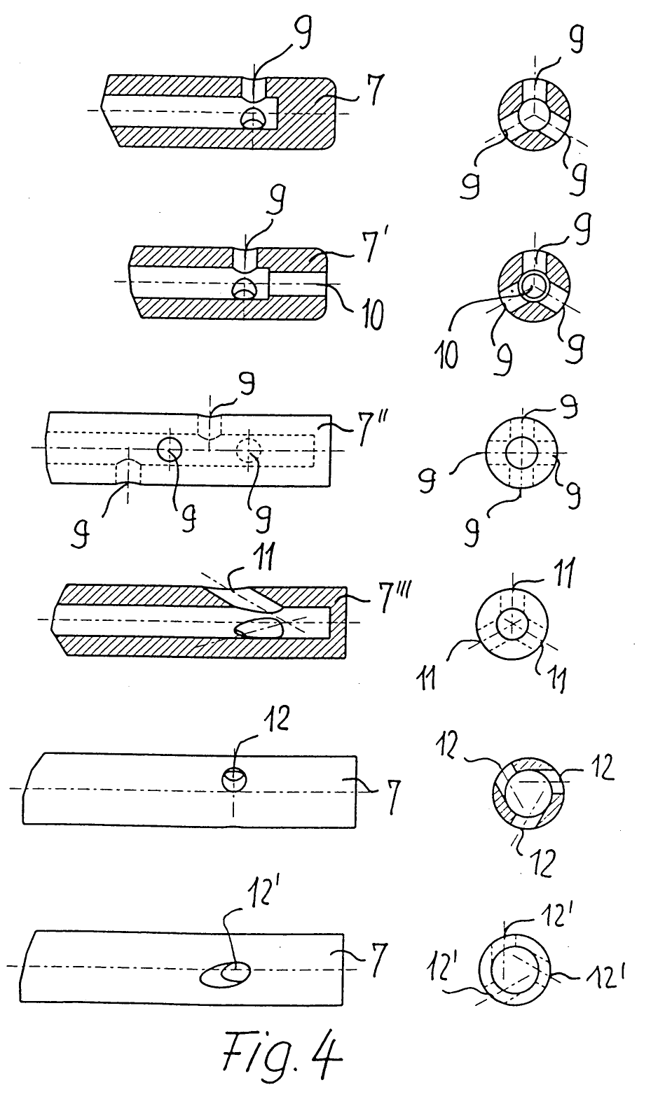

FIG. 3 shows an enlarged cross sectional view of the detail X according to an alternative embodiment of the nozzle piece according to the invention,

FIG. 4 shows an collective view of several alternative designs of the discharge nozzle of the nozzle piece, partly with an enlarged longitudinal section and a corresponding cross section and partly with corresponding views,

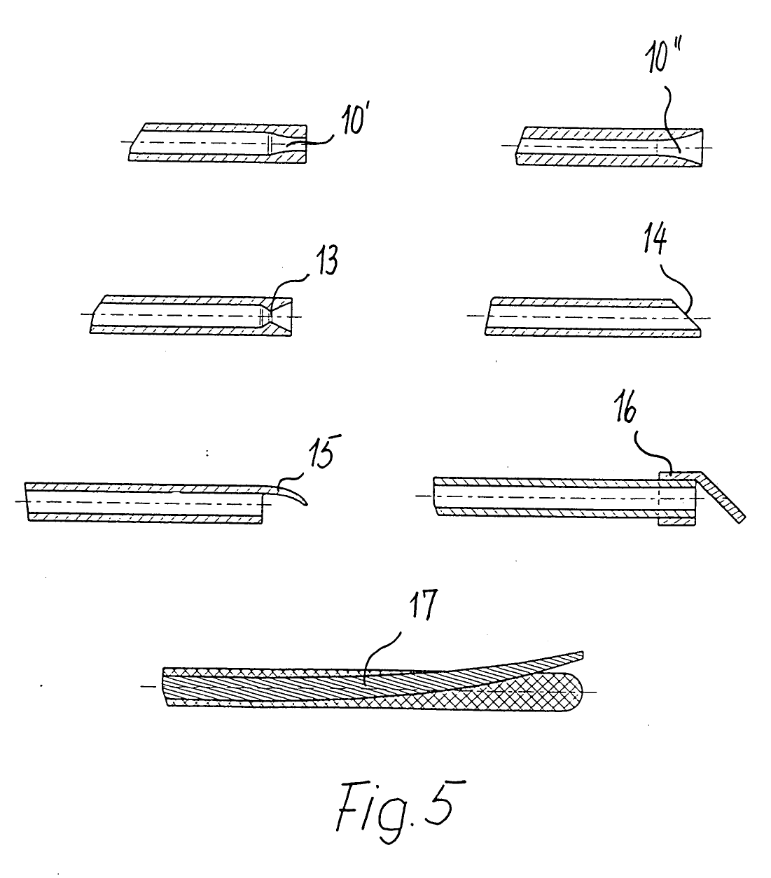

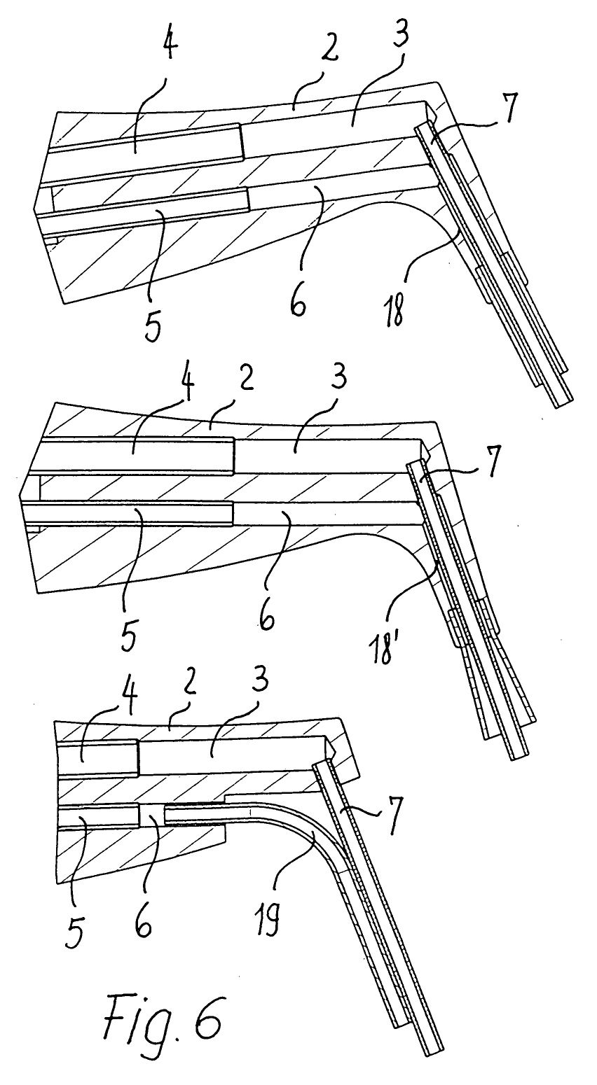

FIG. 5 shows a further collective view of several alternative embodiments of an axial nozzle opening of the discharge nozzle of the nozzle piece,

FIG. 6 shows enlarged cross sectional views of detail X according to further alternative embodiments of the nozzle piece according to the invention, in which an additional fluid discharge nozzle is provided,

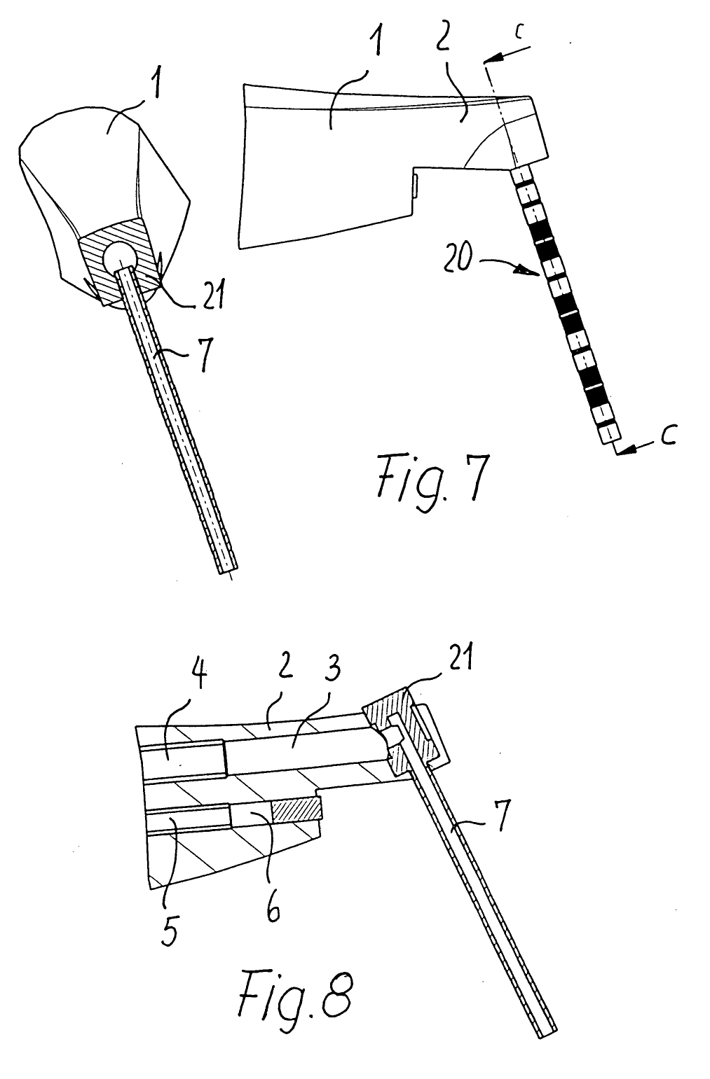

FIG. 7 shows a schematic view of a scale provided as positional marker for the nozzle openings of the discharge nozzle, in a side view and in a sectional view according to line C-C, and

FIG. 8 shows an enlarges cross sectional view of detail X according to a further alternative embodiment of the nozzle piece according to the invention.

The head end of a hand piece shown in FIG. 1 in a very schematic view represents a device according to DE 101 14 324 A1. The exchangeable connection of nozzle piece 2 with a grip sleeve 1 is assumed to be known. The nozzle piece 2 supports a discharge nozzle for air mixed with a dental powder suitable for tooth cleaning, as shown in detail X. The discharge nozzle is connected via a connection passage 3 formed within the nozzle piece 2 with connecting lines 4 led through the grip sleeve, wherein the air-powder-mixture is supplied via the connecting line 4 from a connected storage supply, in order to provide a working jet at the outlet of the discharge nozzle. In the known hand piece, a second connecting line 5 is further provided, which is connected via a second connection passage 3 of nozzle piece 2 to a fluid discharge nozzle, which is concentrically arranged to the discharge nozzle for the air-powder-mixture, and which generates a common fluid jet together with the working jet of the discharge nozzle for the air-powder-mixture, both jets being directed against the relevant preparation field of a tooth when the hand piece is handled accordingly.

The representation in FIG. 1 takes account of the fact that the connecting line 5 terminates in a blind end in the corresponding connecting passage 6 of the nozzle piece 2, and therefore only connecting line 4 has a connection to the corresponding discharge nozzle via the respective connecting passage 3 of the nozzle piece 2. FIG. 2 shows an enlarged cross sectional view of these-connection arrangements in a nozzle piece according to the invention. The discharge nozzle according to detail X in FIG. 1 has a relatively thin-walled tube 7 having a smaller diameter than the connection passage 3. This tube 7 is oriented in an obtuse angle to the axial main axis of the hand piece and is attached to the nozzle piece 2 for a protrusion of for example 15 mm, in order to achieve a working length for the discharge nozzle over a partial length of about 5 mm by means of the front end of the tube. In a sub-gingival powder jet cleaning, which regarded as the main application of the invention, a largely atraumatic insertion of this tube into the gum pockets is allowed thereby.

In comparison to FIG. 2, FIG. 3 shows an alternative embodiment of the discharge nozzle in the nozzle piece according to detail X. Here, the discharge nozzle is also formed with a relatively thin-walled tube 8, which is attached to the nozzle piece 2 with a communication to the connection passage 3 and thereby forms a corresponding tube-shaped partial length at the front end of the outlet cross section of the discharge nozzle. In this alternative embodiment, tube 8 has a curved or arched shape, which is principally designed under the aspect of achieving a closer abutment of the tube to the teeth during a sub-gingival tooth treatment. The arched shape may also receive for example a peel or blade-shaped form, which is known from some dental apparatus for cleaning tooth interstices. Attention is drawn to the fact that the straight shape of the tube according to the representation in FIG. 2 is a generally preferred embodiment of the nozzle piece according to the invention, however this straight design may also be varied in many ways. The tubes 7, which are preferably exchangeably mounted at the nozzle piece 2 as single-use products, may for example have a circular cross section, or even an oval or elliptical cross section. An oval to elliptic cross section of the tube may lead to reduced widening of gum pockets. With such tube 7 and/or 8, the relevant discharge nozzle of the nozzle piece for an air-powder-mixture is obtained, wherein its front end is either closed or may have an axial nozzle opening, as described in the following for different alternatives with respect to the collected representation of FIG. 4 and 5.

The collected representation of FIG. 4 shows in the sequence of top to bottom several embodiments of the outlet cross section of the discharge nozzle formed with tubes 7 and/or 8 in a further enlarged scale. All these embodiments share the feature that the outlet cross section is composed of few nozzle openings in the lateral area of the front end of the tube, which may be axially closed or provided with an axial nozzle opening.

According to a first embodiment, the discharge nozzle has the shape of a tube 7 with a closed end. The outlet cross section of this discharge nozzle is formed with 3 radial passages 9 arranged in a common radial plane of the tube, wherein the radial passages 9 are regularly spaced along the corresponding circumference of the tube. Alternatively, the outlet cross section of the discharge nozzle defined by these radial passages may be enlarged by an additional nozzle opening formed in the closed end of the tube. The next representation of FIG. 4 therefore shows a tube 7′ having an axial nozzle opening 10, which together with the radial passage 9 is connected via the axial cavity of the tube with the connection passage 3 of the nozzle piece 2 and further with connection line 4. Instead of an arrangement of radial passage 9 in a single common radial plane, a multiple arrangement of radial passages in several radial planes may also be provided. The radial passages in adjacent radial planes should thereby be offset or shifted in the axial direction of the tube with respect to each other, as shown for the tube 7″ shown with a closed end. In this embodiment, the outlet cross section of the discharge nozzle has a sieve type arrangement, wherein the distribution of the nozzle openings in the different radial planes of the tube may also be differently arranged.

The nozzle openings forming the outlet cross section of the discharge nozzle may alternatively be executed as beveled passages 11, as shown for tube 7′″ in the next representation of FIG. 4. These beveled passages 11 form an acute angle with the axis of the tube 7′″, the orientation of which is to be understood such that the relevant outlet cross section of each beveled passage is downstream of the corresponding inlet cross section. Wherein the outlet cross sections are disposed in the lateral area of the tube 7′″, the inlet cross sections are positioned in the wall surrounding the cavity of the tube, so that, as for radial passages 9, there is an open connection with connection passage 3 of nozzle piece 2 and further with the connecting line 4, through which the air-powder-mixture is supplied to the tube.

In a further alternative embodiment, the nozzle opening forming the outlet cross section of the discharge nozzle may also be embodied by tangentially oriented or skewed passages 12. The axes of passages 12 either run in a common radial plane of the tube or, as shown for the tangentially oriented or skewed passages 12′, are oriented in an acute angle to the axial plane of the tube. The reference to a tangential or skewed orientation of the passages 12 and 12′, which promotes the formation of eddies or vortices inside the gum pockets, is to be understood in a way that the axes of the passages form a virtual inner circle of the tube. The axes of these passages are tangentially orientated with respect to this inner circle.

In the collective representation of FIG. 5, several alternative embodiments of the axial nozzle opening 10 are shown, which may thereby be combined not only with the radial passages 9, but also with beveled passages 11 and/or with the tangentially oriented and/or skewed passages 12, 12′. In the sequence from top to bottom, FIG. 5 shows an axial nozzle opening 10′ provided with an outlet cross section narrowing in the axial direction. The outlet cross section may also expand in the form of a diffuser, as shown for the axial nozzle opening 10″. The axial nozzle opening may also be designed as a Venturi nozzle 13. In addition to the outlet surface running at a right angle to the axis of the tube, it may be provided with a slanted surface 14 at the outlet end of this axial discharge nozzle. In order to target the air-powder-working jet to the treated surface of a tooth radix, a deflection body 15 may be provided at the axial nozzle opening, wherein the defection body may be integrally formed with the tube, or may be exchangeably mounted using a sleeve 16, which is slid onto the end of the tube. The function of the deflection body may also be achieved with a nozzle opening 17, which is asymmetrically formed such that the air-powder-mixture supplied to this nozzle opening is deflected from its axis.

FIG. 6 shows several possibilities for integrating a fluid discharge nozzle beside the discharge nozzle for the air-powder-mixture into the nozzle piece, according to further alternative embodiments of the nozzle piece according to the invention. These further embodiments are to be understood such that the connection passage 7 of nozzle piece 2 does not have a blind end, but that it is connected, as in the known nozzle piece, with an additionally provided fluid discharge nozzle. The top representation in FIG. 6 thereby essentially corresponds to the known nozzle piece according to DE 101 14 324 A1 and, with its connection passage 3, results in a connection with the discharge nozzle for the air-powder-mixture, wherein the discharge nozzle is embodied here by a tube 7 of the above described characteristics according to the invention. The connection passage 6 of nozzle piece 2 is also connected to a fluid discharge nozzle 18, which is concentrically arranged to tube 7. The mouth of this fluid discharge nozzle 18 is thereby axially displaced backwards with respect to the nozzle openings of the discharge nozzle for the air-powder-mixture. According to the middle representation of FIG. 6, the fluid discharge nozzle 18′ may also be provided with a mouth expanding in the fashion of a diffuser. According to the bottom representation, it may also be contemplated that this additional fluid discharge nozzle is provided with a tube 19 arranged at the outer side of tube 7, which thereby is inserted into the connection passage 6 of nozzle piece 2.

FIG. 7 finally illustrates that a scale 20 and/or a color coding may be provided at the generally tube-shaped partial length of the nozzle piece, in order to mark a certain position of the nozzle openings defining the outlet cross section of the discharge nozzle for the air-powder-mixture. In conjunction with the representation of FIG. 8, the cross sectional view illustrates that for an exchangeable support of tube 7, a holding piece 21 may be provided, which results in a rotatable assembly of the tube with respect to the nozzle piece 2 and thereby in the possibility for a varying positioning of the different nozzle openings.

The nozzle piece according to the invention is primarily intended for sub-gingival powder jet cleaning using a relatively fine-grained dental powder. However, it may also be adapted for supra-gingival powder jet cleaning when using an also rather fine-grained powder. In this application, however, the nozzle pieces should be used with an adapted, somewhat different orientation of the nozzle openings, with which the outlet cross section of the discharge nozzle is formed in the lateral pocket of the tube. The preferred design of the tube as an exchangeable single-use product thereby simplifies the change-over between these two types of powder jet cleaning treatment.

1. A nozzle piece for a dental powder jet apparatus adapted for an exchangeable assembly on a hand piece and having a discharge nozzle for discharging a mixture of air and a dental powder suitable for cleaning piece, as well as a discharge nozzle for a fluid, wherein a front partial length at the outlet cross section of the discharge nozzle projects over a grip (1) of the nozzle piece (2) connected to the hand piece, and wherein the front partial length is formed as a tube (7, 7′, 7″, 7′″, 8) and is provided with nozzle openings (9, 10, 10′, 10″, 11, 12′, 13, 17) in the lateral area of the front end of the tube (7, 7′, 7″, 7′″, 8), wherein the mouth of the discharge nozzle for the fluid is axially displaced backwards with respect to the discharge nozzle (18, 19) for the air-powder-mixture, characterized in that the nozzle opening (9, 10, 10′, 10″, 11, 12, 12′, 13, 17) for the air-powder-mixture and the discharge nozzle (18, 18′, 19) for the fluid have such dimensions and are disposed such that an eddy or vortex formation is promoted inside the treated (sub-gingival) gum pocket.

2. The nozzle piece of claim 1, characterized in that the nozzle openings (9, 11, 12, 12′) are arranged in a common radial plane of the tube (7, 7′, 7″, 7′″)and are spaced in regular distances or in varying distances along the corresponding circumference of the tube.

3. The nozzle piece of claim 1, characterized in that the nozzle openings (9) are arranged in at least two different radial planes of the tube (7″) and in that the nozzle openings in one radial plane are twisted with respect to the nozzle openings in the other radial plane in the circumferential direction of the tube.

4. The nozzle piece according to claim 1, characterized in that the nozzle openings (9) are formed as radial passages.

5. The nozzle piece according to claim 1, characterized in that the nozzle openings (11) are formed as beveled passages, forming an acute angle with the axis of the tube (7′″).

6. The nozzle piece according to claim 1, characterized in that the nozzle openings (12, 12′) are formed as tangentially oriented or skewed passages.

7. The nozzle piece of claim 6, characterized in that the axes of the tangential or skewed passages (12′) are oriented in an acute angle to the axial plane of a tube (7).

8. The nozzle piece according to claim 5 or 6, characterized in that the outlet cross sections of the beveled passages and/or the tangential or skewed passages (12, 12′) are disposed downstream of the corresponding inlet cross sections of the passages.

9. The nozzle piece of claim 6, characterized in that the axes of the tangential or skewed passages (12, 12′) run in a common radial plane of a tube (7).

10. The nozzle piece of claim 1, characterized in that the nozzle openings (17) are elongated or slot-shaped.

11. The nozzle piece according to claim 10, characterized in that a defined longitudinal axis of the slot-shaped nozzle openings (17) is parallel to the main axis of the tube or forms an angle to a lateral area of the tube.

12. The nozzle piece according to claim 2 or claim 3, characterized in that in one or each of the radial planes of the tube (7, 7′, 7″, 7′″) at least three nozzle openings (9, 11, 12, 12′) are disposed along the corresponding circumference of the tube.

13. The nozzle piece according to claim 1, characterized in that the front end of the tube (7, 7′″) is either closed or provided with an axial nozzle opening (10).

14. The nozzle piece according to claim 13, characterized in that the axial nozzle opening (10″) is diffuser-shaped.

15. The nozzle piece according to claim 13, characterized in that the axial nozzle opening (10) is shaped in the style of a venturi nozzle (13).

16. The nozzle piece of claim 13, characterized in that the axial nozzle opening (10) is provided with an outlet cross section (10′) which narrows in the axial direction.

17. The nozzle piece of claim 13, characterized in that the axial nozzle opening (10) is asymmetrically formed in order to deflect the discharged air-powder-mixture jet from the axis of the tube.

18. The nozzle piece of one of claims 13-16, characterized in that a deflection body (15, 16) is provided at the axial nozzle opening (10), the deflection body directing the discharged air-powder-mixture jet against the treated tooth surface.

19. The nozzle piece according to claim 18, characterized in that the deflection body (16) is interchangeably mounted on the tube (7).

20. The nozzle piece of claim 1, characterized in that, the fluid discharge nozzle (18) is concentrically arranged to the discharge nozzle for the air-powder-mixture.

21. The nozzle piece of claim 1, characterized in that the fluid discharge nozzle (18′) is provided with a diffuser-shaped outlet cross section.

22. The nozzle piece according to claim 21, characterized in that the fluid discharge nozzle (19) is disposed on one side of the discharge nozzle for the air-powder-mixture.

23. The nozzle piece of claim 1, characterized in that the tube-shaped front partial length (8) of the nozzle piece (2) has an arched shape ending at the nozzle openings of the discharge nozzle.

24. The nozzle piece of claim 1, characterized in that the tube-shaped front partial length (8) of the nozzle piece (2) has an oval to elliptic cross section.

25. The nozzle piece of claim 1, characterized in that the tube-shaped front partial length (7, 7′, 7″, 7′″, 8) of the nozzle piece (2) is made of a material behaving atraumatically regarding its hardness and surface texture, in particular of polycarbonate or another plastic.

26. The nozzle piece of claim 1, characterized in that a scale (20) and/or a color partitioning for marking the position of the nozzle openings relative to the main axis of the hand piece is provided on the tube-shaped front partial length (7, 7′, 7″, 7′″, 8) of the nozzle piece (2).

27. The nozzle piece of claim 1, characterized in that the tube (7) is composed of a single-use product exchangeably mounted on the grip (1).

28. The nozzle piece of claim 1, characterized in that the tube (7) is held by a holding piece (21) which is rotatable relative to the grip (1).

29. (canceled)
